(19) United States
(12) Patent Application Publication
(10) Pub. No.: US 2026/0295688 A1
(43) Pub. Date: Oct. 1, 2026

(54) MICRO ADJUSTABLE COUNTERSINK TOOL AND RELATED METHODS

(71) Applicant: Katz-Moses Group, LLC, Santa Barbara, CA (US)

(72) Inventors: Jonathan Katz-Moses, Santa Barbara, CA (US); Andrew Klein, Parker, CO (US)

(73) Assignee: Katz-Moses Group, LLC, Santa Barbara, CA (US)

(21) Appl. No.: 19/090,102

(22) Filed: Mar. 25, 2025

(51) Int. Cl. B23B 51/10

(52) U.S. Cl. CPC B23B 51/104

(57) ABSTRACT

A micro-adjustable countersink tool is provided for precise and adjustable depth control during drilling operations. The tool may include a main body with a through hole for receiving a drill bit, a micro barrel with an interior threaded surface for engagement with a threaded portion of the main body, and a locking ring assembly with one or more magnets and a dowel pin for securing a selected tool configuration. A depth ring with windows for debris evacuation and cooling may be rotatably coupled to the micro barrel via a bearing, allowing the depth ring to remain stationary relative to the workpiece while the drill bit and cutting tip rotate. The drill bit and cutting tip depth may be adjusted by disengaging the locking ring assembly, rotating the main body to advance or retract the cutting tip, and then re-engaging the locking assembly to a locked position. The tool may be removably attached to a drilling mechanism, such as a hand drill or drill press, and may be used in aerospace, woodworking, automotive, and machining industries. A method for using the tool is also provided, allowing for precise depth adjustments, controlled countersinking, and efficient material removal.

### FIELD OF THE INVENTION

The present invention relates generally to precision drilling tools and, more particularly, to a micro-adjustable countersink tool that allows for precise and repeatable depth adjustments when creating countersunk bores in a workpiece. The invention integrates a micro adjustment mechanism with a locking ring assembly to enable incremental positioning of a cutting tip, providing enhanced accuracy and control during drilling operations.

### BACKGROUND OF THE INVENTION

Precision tools are essential for achieving accurate and consistent results in a variety of machining and manufacturing operations. Among these tools, micro adjustable mechanisms and countersink tools play a significant role in industries such as aerospace, automotive, woodworking, and general machining.

A micrometer is a device that allows for fine, precise measurements, typically by means of a threaded spindle and corresponding scale or dial. These mechanisms are widely employed in tools and machines where controlled movement or measurement is required, such as in calipers, depth gauges, and cutting tools. The high degree of precision offered by micro adjustments makes them an ideal solution for applications requiring incremental positioning and repeatability.

Countersink tools, on the other hand, are specifically designed to create a conical hole in a workpiece, allowing a screw, bolt, or rivet head to sit flush with or below the surface when inserted. Countersinking is a critical operation in applications where smooth finishes, proper load distribution, and aesthetic considerations are important. Traditionally, countersink tools include a cutting blade or edge that is set to a specific depth. However, many existing countersink tools lack sufficient versatility or precision, making it challenging to adjust the depth of the countersink without replacing components or relying on time-consuming manual adjustments.

Existing solutions that integrate adjustable depth features in countersink tools often suffer from limitations. For example, some rely on cumbersome adjustment mechanisms that require disassembly or specialized tools to alter the cutting depth. Others lack the precision needed for high-tolerance applications, resulting in inconsistent or inaccurate results. Many such tools are not easily adaptable for different materials or workpiece geometries, limiting their utility.

There is, therefore, a need for an improved countersink tool that incorporates an adjustable depth mechanism. Ideally, such a tool would leverage a micro adjustment mechanism to enable precise, incremental depth adjustments without requiring additional tools or extensive downtime. Moreover, the adjustable depth mechanism should be robust, user-friendly, and compatible with a variety of applications and materials. Addressing these needs would enhance the efficiency and versatility of countersinking operations while ensuring superior accuracy and consistency.

The present invention addresses these deficiencies by providing a novel combination of a micro adjustment mechanism and a countersink tool with an adjustable depth, offering an improved solution for precision machining tasks.

### SUMMARY OF THE INVENTION

Embodiments of the present invention provide countersink tools that may include a micro adjustment mechanism incorporated into the countersink tool to enable precise depth control during drilling operations. Embodiments of the present invention may allow a user to adjust the depth of a cutting tip and drill bit by rotating a micro barrel, which engages with a threaded portion of a main body. Embodiments of a locking assembly may be utilized to secure the tool in a fixed position for use after a depth adjustment has been made. The locking assembly may be easily disengaged to allow for incremental depth adjustments without requiring disassembly or additional tools. Embodiments of the present invention may be configured for use with various drilling mechanisms, including without limitation hand drills and drill presses, allowing for versatile application in woodworking, aerospace, automotive, and general machining industries.

Embodiments of the present invention include a main cylindrical body having a through hole operable to receive a drill bit. One end of the main body is provided with a shank, and the opposite end is provided with a shaft. Embodiments of the shaft have a smooth exterior cylindrical surface adjacent to the main cylindrical body, followed by a groove for receiving a retaining ring, followed by a threaded region. When installed, the retaining ring separates the smooth region of the shaft from the threaded region. An end surface of the main cylindrical body is provided with a plurality of blind holes radially positioned around the shaft which are used by the locking mechanism described below.

In embodiments of the invention, a micro barrel having a bore at one end with complementary threads therein is provided for adjustably rotatable engagement with the threaded end of the shaft on the main body, allowing for axial adjustment of the cutting tip position. Rotation of the micro barrel relative to the main body in one direction (e.g., clockwise) may contract the overall length of the present tool, causing more exposure of the drill bit and cutting tip for a deeper countersink bore in a work piece. Similarly, rotation of the micro barrel in an opposite direction (e.g., counter-clockwise) may expand the overall length of the present tool, causing less exposure of the drill bit and cutting tip for a more shallow countersink bore in a work piece. A depth ring may be provided at the opposite end of the micro barrel for placement against a work piece. The depth ring may be rotatably coupled to the micro barrel using a bearing, allowing the depth ring to remain stationary relative to the workpiece while the main body, micro barrel, drill bit and cutting tip rotate.

Embodiments of the micro barrel are provided with a plurality of radially distributed longitudinal slots for receiving corresponding structures of a locking assembly. Embodiments of the locking assembly may include an outer cylindrical body and an interior cylindrical body connected by a plurality of radially extending supporting members. These support members may be slidably engaged with the longitudinal slots of the micro barrel. One or more embedded magnets and at least one dowel pin that is longer than the magnets are provided, which protrude from a proximal end of the interior cylindrical body of the locking assembly. In an embodiment in a locked position, the dowel pin engages with one of the plurality of blind holes on the side surface of the main body, with the one or more magnets holding the locking assembly against the main body. In this position, rotation may be imparted through the entire embodiment of the tool with the exception of the depth ring: from the shank to the main body, from the dowel pin engaged with the main body to the locking assembly, and from the locking assembly through the radial supports to the micro barrel. The depth ring may not rotate because of the bearing separating the depth ring from the micro barrel.

To adjust the cutting depth, a user may pull the locking ring assembly away from the main body, removing the dowel pin from the blind hole and disengaging and one or more magnets. The main body may then be rotated, advancing or retracting the threaded portion through the interior surface of the micro barrel until the desired depth is reached. The locking ring assembly may then be released and returned to the locked position, with the dowel pin engaging one of the blind holes, securing the configuration for use.

It is to be appreciated that in some cases, upon such release, the dowel pin may not align exactly with one of the blind holes, such that a minor rotation in one direction or another may be needed to align the dowel pin with a blind hole. In most embodiments, providing between five and eight blind holes will allow the tools of the present invention to generally adjust for most known screw head sizes. However, in some embodiments, a larger number of blind holes may be provided in the main body to reduce the number of occasions of non-alignment. Embodiments may include additional blind holes by reducing the size of the holes and the size of the dowel pin that fits into them. In other embodiments, which may be implemented separate from or in addition to adding more blind holes, different depths of the threads on the main body and the micro barrel may be provided. The use of more narrow threads on these complementary parts will result in very slight adjustments in length resulting from any additional rotation needed to line up the dowel pin with a blind hole. The use of wider threads will result in more length adjustment from rotation.

Embodiments of the depth ring may include at least one window to allow for debris evacuation and cooling airflow, improving cutting efficiency and preventing material buildup around the cutting tip. Embodiments of the main body may further include a plurality of indicator marks on a mid-region over which an end of the micro barrel extends, which may be used to determine the desired depth as the micro barrel is rotated relative to the main body. A set screw may be provided in the main body to secure the drill bit in place within the through hole. Additionally, the cutting tip may be secured around the drill bit using a separate set screw, allowing for easy replacement and adjustment of the cutting components.

Embodiments of the present invention may also include a drilling countersink tool attachment device that may include a drilling mechanism having a chuck operable to secure the micro-adjustable countersink tool. The micro-adjustable countersink tool may be removably coupled to the chuck and may include the aforementioned features, enabling precise depth control and secure locking of the cutting depth.

Embodiments of the invention further provide methods for creating a countersunk hole and bore hole, which may include securing the micro-adjustable countersink tool to a drilling mechanism; adjusting the cutting tip depth by disengaging the locking ring assembly, rotating the main body, and re-engaging the locking ring; drilling into a workpiece until the depth ring contacts the top surface; and removing the tool to leave a bore and countersunk profile corresponding to the cutting tip and drill bit configuration. The methods may further include comparing the indicator marks on the main body to the top edge of the micro barrel to ensure precise depth adjustments before securing the locking ring assembly. The depth ring may remain stationary relative to the workpiece due to a bearing coupling, and debris evacuation may be facilitated through the plurality of windows in the depth ring, improving cooling and reducing material buildup during operation.

Some aspects of the invention include a micro adjustable countersink tool comprising a main cylindrical body, a shank extending out from a proximal end of the main body, a cylindrical shaft extending out from a distal end of the main body, and an axial bore in said shaft operable to receive a drill bit. In these aspects, the shaft may have a diameter that is smaller than the diameter of the main body defining a circular end surface on the main body around a proximal end of the shaft, the shaft having an annular exterior slot thereon, wherein a plurality of blind holes are provided on the circular end surface of the main body, and wherein threading is provided on a portion of an exterior surface of the shaft between the annular slot and a distal end of the shaft. These aspects include a discontinuous ring operable for engagement with said exterior slot; a barrel having a threaded axial bore at a first end thereof operable for rotatable engagement with the threading on said shaft, and an annular shoulder at said first end, said barrel including a plurality of radially distributed arms at an opposite end, said arms being separated by a plurality of radially distributed longitudinal slots. These aspects also include a locking ring assembly comprising an outer cylindrical body, a hollow interior cylindrical body, and a plurality of radially distributed support members connecting the outer cylindrical body to the inner cylindrical body, wherein the radially distributed support members are operable for slidable engagement with the radially distributed longitudinal slots of said barrel, said locking ring assembly further comprising at least one dowel pin protruding from a proximal end of said interior cylindrical body, and one or more magnets located on said proximal end of said interior cylindrical body, wherein said dowel pin is operable for temporary engagement with at least one of said plurality of blind holes on the main body, and said one or more magnets are operable for temporary engagement with the circular end surface of the main body. These aspects may also include a depth ring having an annular shoulder at one end thereof; a bearing operable for engagement between the annular shoulder of said barrel and the annular shoulder of said depth ring; a drill bit operable for removable insertion into the axial bore of said the shaft of the main body that is operable for drilling a hole in a workpiece; and a cutting tip positioned at a distal end of the drill bit and operable to cut a countersink bore in said workpiece.

In some aspects, rotation of the threaded bore of said barrel relative to the threaded region of the shaft in a first direction increases the length of the tool resulting in a shallow cutting depth for the drill bit and cutting tip; and rotation of the threaded bore of said barrel relative to the threaded region of the shaft in an opposite second direction decreases the length of the tool resulting in a greater cutting depth for the drill bit and cutting tip.

In some aspects, a position of the barrel relative to the main body is temporarily fixed by sliding the locking ring along the slots of the barrel towards the main body allowing for engagement of the at least one locking pin with one of the plurality of blind holes. In some of these aspects, the fixed position of the barrel against the main body is temporarily maintained by engagement of the one or more magnets with the cylindrical surface of the main body. In some of these aspects, rotation of the barrel relative to the main body is made possible by sliding the locking ring along the slots of the barrel away from the main body causing disengagement of the locking pin from one of the plurality of blind holes. In related aspects, measuring indicia are provided on an exterior surface of said main body; and an opening may be provided on an exterior surface of the main body for receiving a set screw that is operable to fix the drill bit in the axial bore of the shaft. In related aspects, the discontinuous ring may establish a limit for rotation of the barrel relative the main body; the cutting tip may be secured around said drill bit using a second set screw; and the depth ring may include at least one window operable to cool the cutting tip and evacuate wood cuttings from the workpiece.

It is another aspect of the present invention to provide a micro-adjustable countersink tool that may include a main body having a through hole operable to receive a drill bit, a proximal end with a shank, and a distal end having a plurality of blind holes radially positioned around a shaft with a smooth region and a threaded region separated by a retaining ring. A micro barrel may include a receiving cylinder with a plurality of radially distributed longitudinal slots and a stepped bore extending from the base, where the stepped bore may include an interior surface with threading and an exterior surface securing a depth ring that may be rotatably coupled via a bearing. A locking ring assembly may include an outer cylindrical body and an interior cylindrical body connected to the outer cylindrical body by a plurality of supporting members, one or more magnets, and at least one dowel pin protruding from a proximal end of the interior cylindrical body, where the dowel pin may engage at least one of the plurality of blind holes on the main body to selectively lock the main body in position. A cutting tip may be positioned at the distal end of the tool and may be operable to countersink a bore in a workpiece. A position of the drill bit and cutting tip may be adjusted by advancing the threaded region of the main body through the interior surface of the micro barrel to a desired depth, and the locking ring may be disengaged by biasing the locking ring away from the main body.

It is a further aspect of the present invention to provide a main body that may include a plurality of indicator marks on a mid-region and a set screw that may be operable to fix the drill bit in the through hole. The smooth region of the main body may include a slidable region for the locking ring assembly to configure the tool in a locked position and an adjustable position. The adjustable position may be held in a disengaged position while turning the main body to advance the depth. The adjustable position may configure the micro barrel and locking ring assembly in a static position relative to each other. The cutting tip may be secured around the drill bit using a set screw. The depth ring may include at least one window operable to cool the cutting tip and evacuate wood cuttings from a workpiece. The receiving cylinder of the micro-adjustable tool may include a bottom surface, and the adjustable length of the main body may be defined by the region between the retaining ring and the bottom surface. The micro barrel may include a top edge that may be compared to the indicator marks to indicate the depth of the cutting tip.

It is another aspect of the present invention to provide a drilling countersink tool attachment device may include a drilling mechanism having a chuck operable to secure a cutting tool, and a micro-adjustable countersink tool removably coupled to the chuck. The micro-adjustable countersink tool may include a main body having a proximal end with a shank for engagement with the chuck and a distal end with a through hole operable to receive a drill bit, where the main body may further include a threaded portion and a plurality of blind holes. A micro barrel may include an interior threaded surface configured to engage with the threaded portion of the main body, where rotation of the micro barrel may axially adjust the distal end of the tool. A locking ring assembly may include an outer cylindrical body, an interior cylindrical body connected by a plurality of supporting members one or more embedded magnets, and at least one dowel pin configured to engage with at least one of the plurality of blind holes to selectively lock the micro barrel in position. A depth ring may be secured to the micro barrel, where the depth ring may include a plurality of windows operable to facilitate debris evacuation and cooling airflow. A cutting tip may be secured at the distal end of the tool and may be operable to form a countersunk bore in a workpiece when the tool is engaged with the drilling mechanism. One or more magnets may be positioned between the plurality of blind holes when configured in the locked position.

It is another aspect of the present invention to provide a method for creating a countersunk hole and bore hole may include coupling a micro-adjustable countersink tool to a drilling mechanism by securing a shank of the tool into a chuck of the drilling mechanism. A cutting tip depth may be adjusted by biasing a locking ring assembly away from a main body to disengage a locking mechanism, where the locking mechanism may include one or more embedded magnets and at least one dowel pin that engages with a plurality of blind holes on the main body. The main body may be rotated relative to a micro barrel, where the micro barrel may include an interior threaded surface engaged with a threaded portion of the main body, thereby axially advancing or retracting the distal end of the tool. The locking ring assembly may be re-engaged to secure the cutting tip in a desired position. The drill bit may be aligned with a workpiece, and the drilling mechanism may be activated to rotate the micro-adjustable countersink tool. The tool may be drilled into the workpiece until a depth ring contacts a top surface of the workpiece, where the depth ring may include a plurality of windows for debris evacuation and airflow. The micro-adjustable countersink tool may be removed from the workpiece, leaving a bore and countersunk profile corresponding to the configuration of the cutting tip and drill bit. The cutting tip depth adjustment may further include comparing a top edge of the micro barrel to a plurality of indicator marks on the main body to determine the precise depth setting before securing the locking ring assembly. The depth ring may remain stationary relative to the workpiece while the drill bit and cutting tip rotate due to a bearing coupling between the depth ring and the micro barrel. Debris generated during drilling may be evacuated through the plurality of windows in the depth ring, allowing airflow to cool the cutting tip and prevent material buildup.

Further aspects and embodiments will be apparent to those having skill in the art from the description and disclosure provided herein.

It is, therefore, an object of the present invention to provide a micro-adjustable countersink tool that allows for precise and repeatable depth adjustments by utilizing a threaded micro barrel and indicator marks, enabling a user to configure the cutting tip and drill bit to a predefined depth with high accuracy

It is also an object of the present invention to provide a locking and adjustment mechanism that ensures secure positioning of the tool components while allowing for quick and precise depth adjustments, thereby improving ease of use and operational efficiency.

It is also an object of the present invention to enhance drilling performance and tool longevity by incorporating features for debris evacuation and cooling, reducing material buildup, minimizing overheating, and ensuring smooth operation across multiple drilling applications.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of a micro-adjustable countersink tool, according to an embodiment of the present invention.

FIG. 2 provides a side view of a micro-adjustable countersink tool, according to an embodiment of the present invention.

FIG. 3 provides a top view of a micro-adjustable countersink tool, according to an embodiment of the present invention

FIG. 4 provides a bottom view of a micro-adjustable countersink tool, according to an embodiment of the present invention

FIG. 5 provides an exploded perspective view of a micro-adjustable countersink tool, according to an embodiment of the present invention.

FIG. 6 provides a bottom view of a micro-adjustable countersink tool main body, according to an embodiment of the present invention.

FIG. 7 provides a perspective view of a micro-adjustable countersink tool main body, according to an embodiment of the present invention.

FIG. 8 provides a side view of a micro-adjustable countersink tool main body, according to an embodiment of the present invention.

FIG. 9 provides an exploded perspective view of a locking ring assembly, according to an embodiment of the present invention.

FIG. 9A provides an assembled perspective view of a locking ring assembly, according to the embodiment of FIG. 9.

FIG. 10 provides a bottom view of a locking ring assembly, according to an embodiment of the present invention.

FIG. 11 provides a side view of a micro-adjustable barrel, according to an embodiment of the present invention.

FIG. 12 provides a cross-section view of the micro-adjustable barrel, according to an embodiment of the present invention.

FIG. 13 provides a distal view of a locking ring assembly engaging with the main body of a micro barrel, the main body blind holes being transparent, according to an embodiment of the present invention.

FIG. 14 provides a side view of a micro-adjustable countersunk tool in a recessed position, according to an embodiment of the present invention.

FIG. 15 provides a side view of a micro-adjustable countersunk tool in an extended position, according to an embodiment of the present invention.

FIG. 16 provides a top view of a micro-adjustable countersunk in the maximum position and a locked position, according to an embodiment of the present invention

FIG. 16A provides a semi cross sectional side view of a micro-adjustable countersunk about the section line of FIG. 16, according to an embodiment of the present invention.

FIG. 17 provides an exemplary side view of a micro-adjustable countersink tool engaged with a workpiece, according to an embodiment of the present invention.

FIG. 18 an exemplary view of a micro-adjustable countersink tool equipped to a drilling mechanism, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

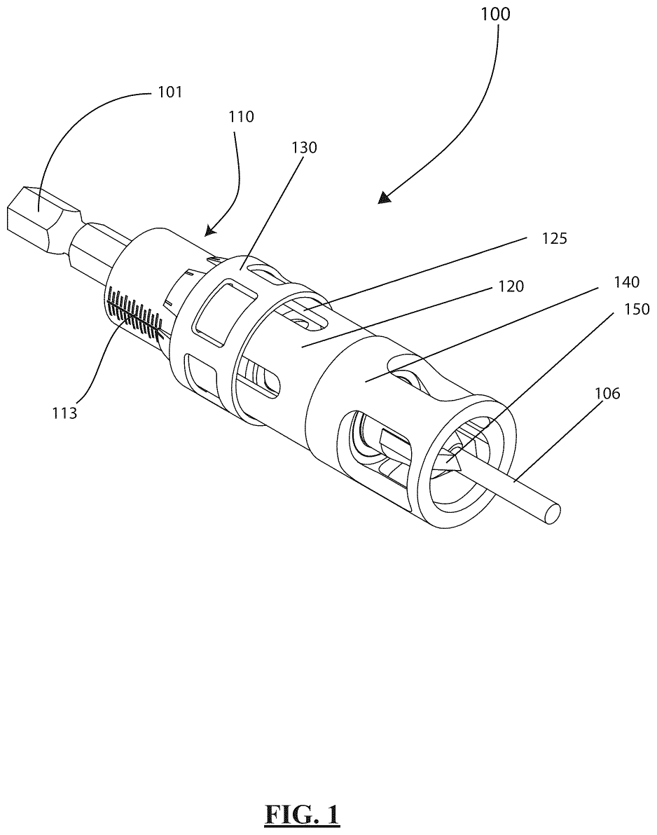

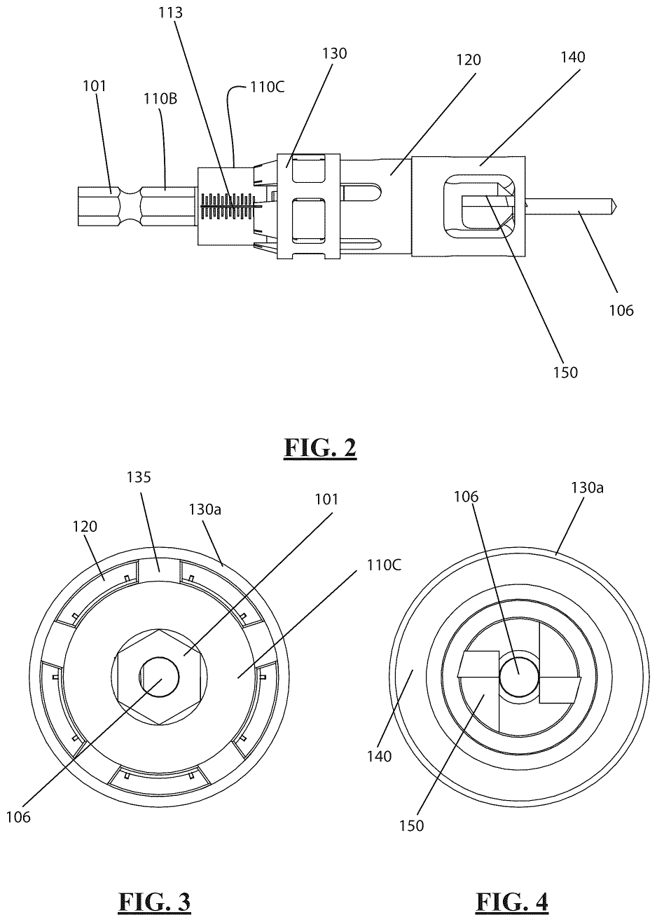

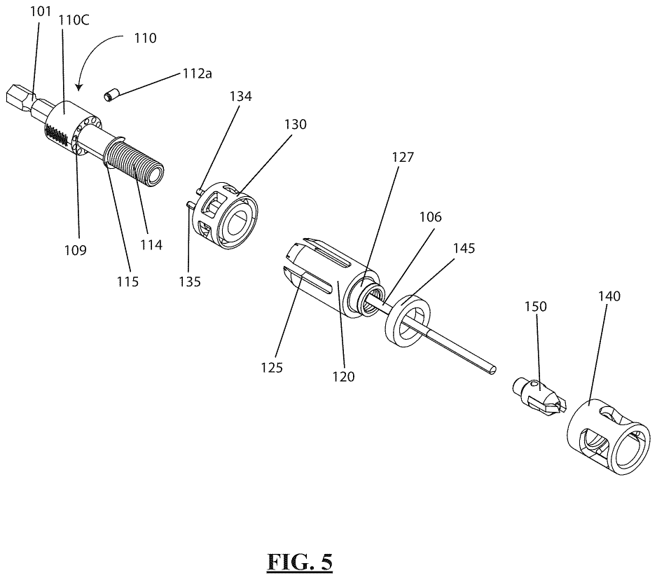

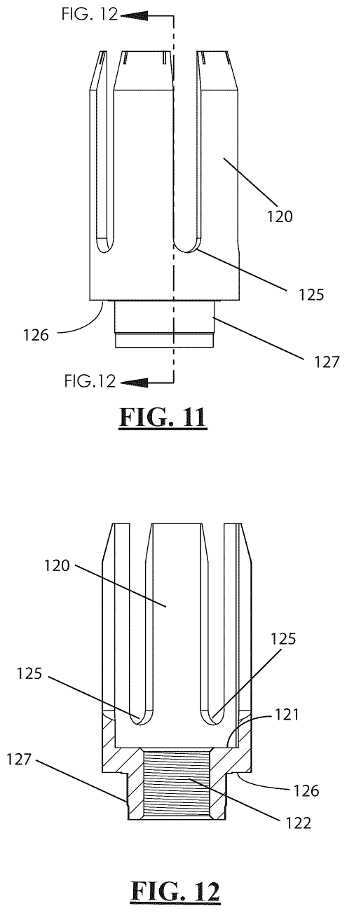

Referring to the drawings, wherein like reference characters designate like or corresponding parts throughout the several views, and referring particularly to FIGS. 1-17, it is seen that the present invention contains various views of a micro adjustable countersink tool that is operable to reproducibly and precisely drill holes in a workpiece to a predefined depth that is configured by the user. The illustrated embodiment of the present invention provides a micro adjustable countersink tool 100 that is operable to precisely configure the drill depth of a countersunk cutting tip by axially adjusting the body of the tool such that the tool only drills to a specific depth. With reference to FIG. 1, it is seen that embodiments of the tool 100 may include a main body 110 adjustably rotatably coupled to a barrel 120, a locking ring assembly 130, a depth ring 140, a cutting tip 150, and a drill bit 106.

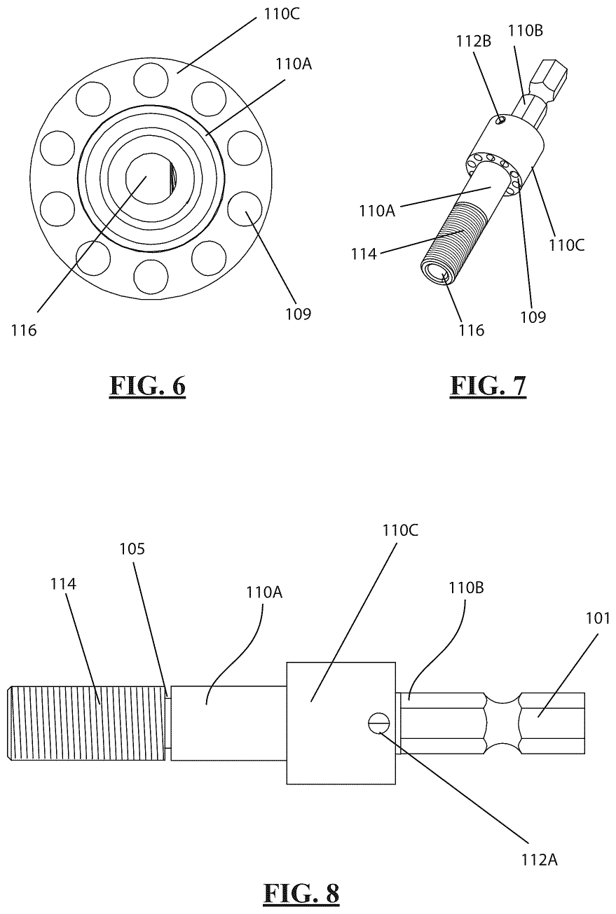

Referring to the embodiments shown in FIGS. 1 and 2, it is seen that the main body 110 may include a cylindrical central region 110C having measuring indicia such as a plurality of indicator marks 113 on one or both sides thereof. Referring to FIG. 7, it is seen that in some embodiments, an opening 112B may be provided in main body 110C to receive a set screw 112A that is operable to secure a removable and replaceable drill bit 106 in through hole 116. Referring to FIG. 8, it is seen that in some embodiments, main body 110 may include a proximal end 110B having a shank 101 extending from the mid-region 110C for engagement with a drill or other motion imparting tool; and may include a distal end 110A having a shaft with a threaded portion 114 and a groove 105 operable to receive a retaining ring 115. As illustrated in FIGS. 6 and 7, main body 110 may have a through hole 116 that is operable to receive a drill bit 106 and may include a plurality of radially distributed blind holes 109 on a proximal end of cylinder 110C.

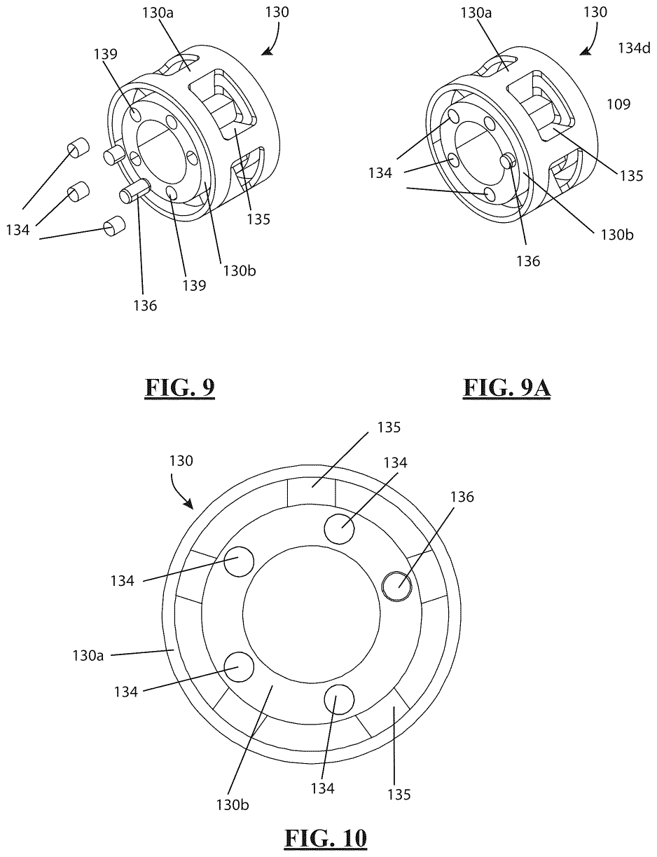

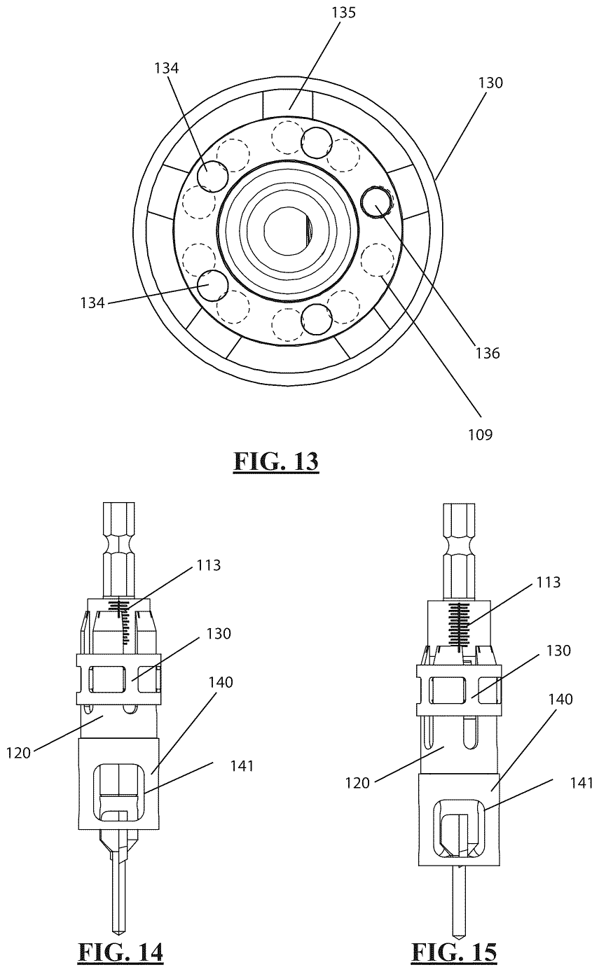

As shown in FIGS. 9-10, the locking ring 130 may include an outer cylindrical body 130a and an interior cylindrical body 130b that are connected by a plurality of radially extending supporting members 135. The interior cylindrical body 130b may include one or more magnets 134 embedded into a plurality of holes 139, and at least one dowel pin 136 that is longer than any of magnets 134. Dowel pin 136 and protrudes outward from the cylindrical body 130b to engage with at least one of the radially distributed blind holes 109 on the main body 110C, thereby providing a locking mechanism. When configured in a locked position, as illustrated in FIG. 13, dowel pin 136 extends into one of the blind holes 109 on the surface of cylindrical body 110C. The blind holes are spaced such that when dowel pin 136 extends into one of the blind holes, none of the one or more magnets 134 are aligned with any of the other blind holes 109; instead, when dowel pin 136 is engaged with one of the blind holes 109, all of the magnets 134 make contact with the surface of cylindrical body 110C between the blind holes 109, thereby maintaining magnetic engagement between the locking body 130 and main body 110. In each locked position for dowel pin 136 (i.e., when dowel pin 136 extends into each of the blind holes 109), the one or more magnets 134 are be staggered between the blind holes 109, and none of them extends into a blind hole 109. It is to be appreciated that in different embodiments, magnet(s)s 134 may have different shapes, such as without limitation round, arcuate, square, rectangular, triangular, or other different shapes, or combinations thereof. For example and without limitation, a single large arcuate magnet may be used.

In embodiments of the invention, the micro barrel 120 includes a plurality of longitudinal slots 125 that are radially distributed. Each slot 125 has a width that is complementary to the width of a supporting member 135, allowing the locking ring 130 to slidably engage micro barrel 120 with the supporting members 135 traversing along the length of the slots 125. In most embodiments, the number of slots 125 and the number of supporting members 135 may be equivalent. Ends of the micro barrel extend over the measuring indicia 113 of the main body. Rotating the micro barrel relative to the main body will change the length of the overall tool, and the amount of the change may be observed by comparing the ends of the micro barrel to the measuring indicia 113. The micro barrel 120 may have a stepped collar 127 at one end defining an annular shoulder 126. Collar 127 may include an interior bore having threading 122 that are operable to engage with the exterior threading 114 of the main body 110A.

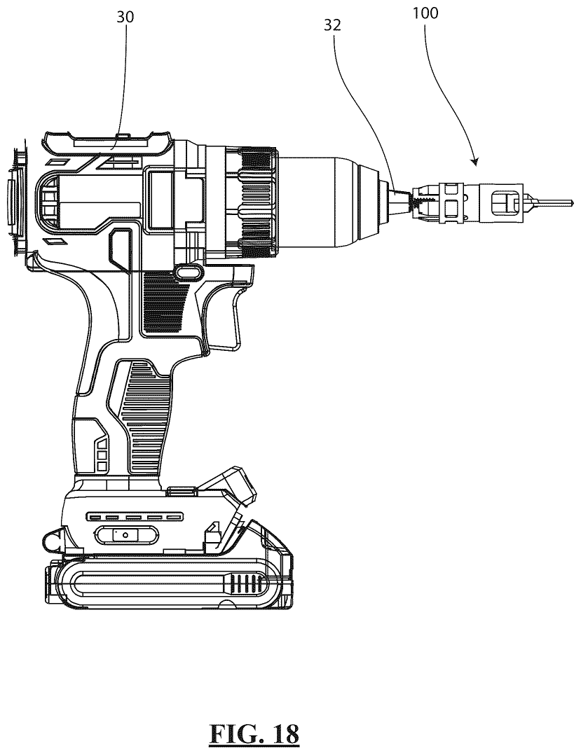

In some embodiments, a depth ring 140 may be provided to serve as a tool guard. Depth ring 140 and may include a plurality of windows 141 that provide a view of the cutting tip 150, and also provide a passage for the evacuation of cuttings and debris removed from a workpiece during drilling. Windows 141 also allow air to cool the cutting tip 150. A rotatable bearing 145 may be fitted between the outside shoulder 126 of collar 127 and an interior shoulder 146 of depth ring 140. Bearing 145 allows the depth ring 140 to remain in a static position against a work piece while the drill bit 106 and cutting tip 150 are rotating to remove material from the workpiece 60 as illustrated in FIG. 17. In some embodiments, the bearing 145 may be press fit to shoulders 126 and/or 146.

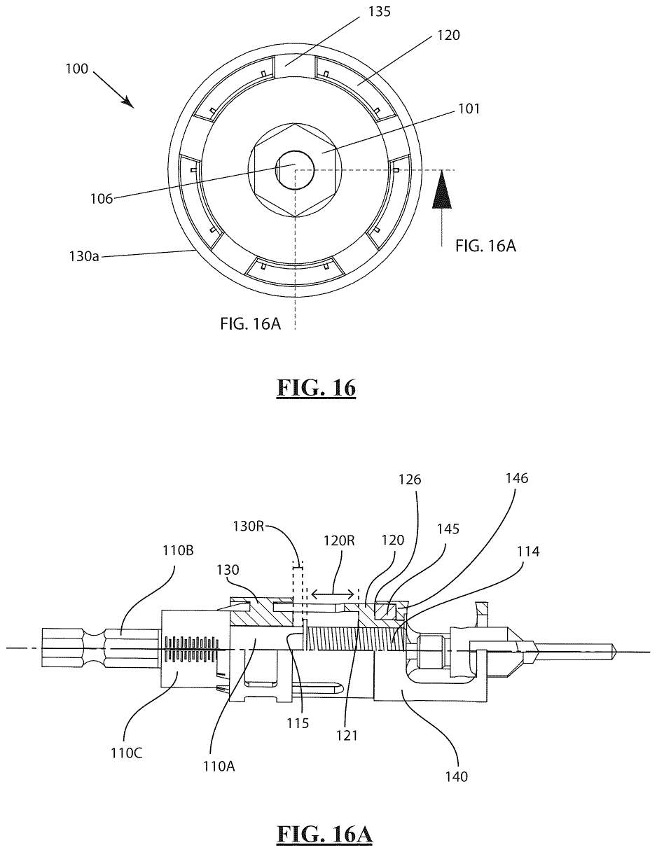

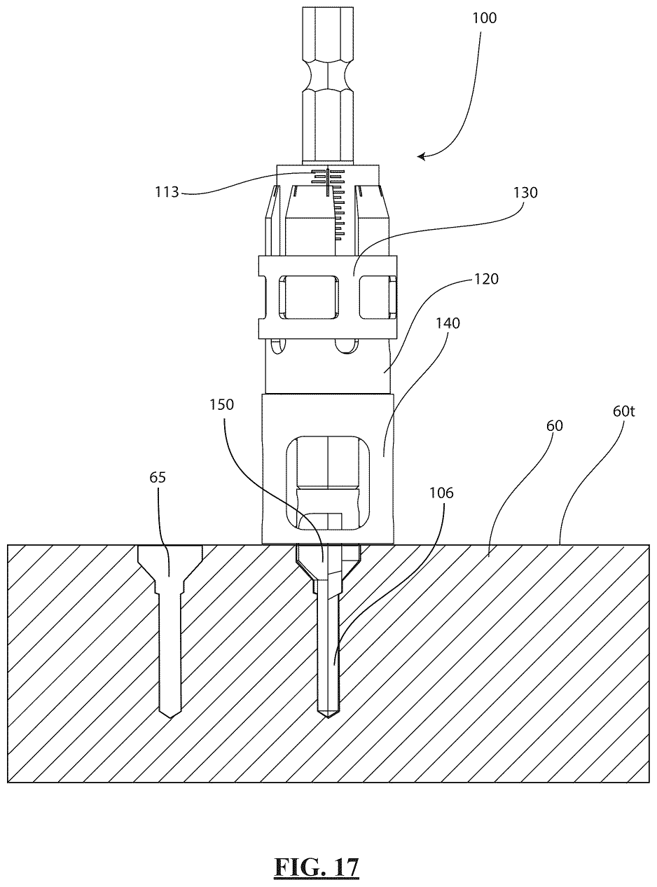

FIG. 16A provides a semi cross-sectional view of an embodiment of the depth ring 140, bearing 145, and micro barrel 120. To adjust the position and depth of the cutting tip 150, a user may move (slide) the exterior body 130a of the locking ring 130 away from the main body 110 to disengage the one or more magnets 134. The locking mechanism disengagement may have a throw length 130R where the distal end of the locking ring 130 bottoms out against the retaining ring 115. The disengagement action releases the engagement between the one or more magnets 134 and the main body 110, and removes dowel pin 136 from a blind hole 109. Once the locking mechanism is disengaged the locking ring 130, a user may adjust the length by rotating the main body 110 relative to micro barrel 120. Rotation in one direction will advance or the threading 114 of body 110A into the threading 122 of the micro barrel 120, thereby reducing length; rotation in the opposite direction will retract the threading 114 from threading 122, thereby increasing length. The range of adjustable length 120R is defined by the region between the retaining ring 115 and the bottom surface 121 of the micro barrel. The measuring indicia 113 on the main body 110 may assist the user in making precise length adjustments through rotation of main body 110. After achieving the desired position of the cutting tip 150, the user may return (release) the locking ring 130 to the locked position, such that the one or more magnets 134 pull towards and engage against surface 110A on the main body 110, and dowel pin 136 engages a blind hole 109 on surface 110A, thereby securing the tool configuration. FIG. 14 illustrates an embodiment of the invention 100 at a high-depth countersunk position, in which threading 114 and been threaded into threading 122, reducing overall length of the tool and exposing more of the cutting tip 150. By comparison, FIG. 15 illustrates an embodiment of the tool 100 at a minimal length position in which threading 114 and been threaded out of threading 122, increasing overall length of the tool 100 and exposing less (or none) of the cutting tip 150.

As illustrated in FIG. 18 the countersink tool 100 may be secured to a drilling mechanism 30 (e.g., drill press, hand drill, etc.), by securing the shank 101 to the chuck 32 of the drilling mechanism. In operation, as illustrated in FIG. 17, after the length of the tool 100 has been established (by rotating body 110 relative to barrel 120 until a desired length is reached), a user may align the drill bit 106 with the workpiece 60 and may drill into the work piece until the bottom surface of the depth ring 140 makes contact with the top surface 60t of the workpiece 60. Once this position is reached, and the cutting tip is no longer cutting the workpiece, a user may remove tool 100 from workpiece 60 and leave a bore and countersunk profile 65 that is complimentary to the configuration and of the cutting tip 150, and drill bit 106 relative to the depth ring 140.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A micro adjustable countersink tool comprising:
a. a main cylindrical body, a shank extending out from a proximal end of the main body, a cylindrical shaft extending out from a distal end of the main body, and an axial bore in said shaft operable to receive a drill bit, the shaft having a diameter that is smaller than the diameter of the main body defining a circular end surface on the main body around a proximal end of the shaft, the shaft having an annular slot on an exterior surface thereof, wherein a plurality of blind holes are provided on the circular end surface of the main body, and wherein threading is provided on a portion of the exterior surface of the shaft between the annular slot and a distal end of the shaft;
b. a discontinuous ring operable for engagement with said annular slot;
c. a barrel having a threaded axial bore therein operable for rotatable engagement with the threading on said shaft, and an annular shoulder at a first end of said barrel, said barrel including a plurality of radially distributed arms at an opposite end of said barrel, said arms being separated by a plurality of radially distributed longitudinal slots;
d. a locking ring assembly comprising an outer cylindrical body, a hollow interior cylindrical body, and a plurality of radially distributed support members connecting the outer cylindrical body to the inner cylindrical body, wherein the radially distributed support members are operable for slidable engagement with the radially distributed longitudinal slots of said barrel, said locking ring assembly further comprising at least one dowel pin protruding from a proximal end of said interior cylindrical body, and at least one magnet located on said proximal end of said interior cylindrical body, wherein said dowel pin is operable for temporary engagement with one of said plurality of blind holes on the main body, and said at least one magnet is operable for temporary engagement with the circular end surface of the main body;
e. a depth ring having an annular shoulder at one end thereof; and
f. a bearing operable for engagement between the annular shoulder of said barrel and the annular shoulder of said depth ring.

2. The tool of claim 1, wherein rotation of the threaded bore of said barrel relative to the threaded region of the shaft in a first direction increases the length of the tool resulting in a shallow cutting depth; and wherein rotation of the threaded bore of said barrel relative to the threaded region of the shaft in an opposite second direction decreases the length of the tool resulting in a greater cutting depth.

3. The tool of claim 1, wherein a position of the barrel relative to the main body is temporarily fixed by sliding the locking ring along the slots of the barrel towards the main body allowing for engagement of the at least one locking pin with one of the plurality of blind holes.

4. The tool of claim 3, wherein the fixed position of the barrel against the main body is temporarily maintained by engagement of the at least one magnet with the cylindrical surface of the main body.

5. The tool of claim 1, wherein rotation of the barrel relative to the main body is made possible by sliding the locking ring along the slots of the barrel away from the main body causing disengagement of the at least one locking pin from one of the plurality of blind holes.

6. The tool of claim 1, wherein a plurality of measuring indicia are provided on an exterior surface of said main body.

7. The tool of claim 1, wherein an opening is provided on an exterior surface of the main body for receiving a set screw that is operable to fix the drill bit in the axial bore of the shaft.

8. The tool of claim 1, wherein the discontinuous ring establishes a limit for rotation of the barrel relative the main body.

9. The tool of claim 1 further comprising a drill bit operable for removable insertion into the axial bore of said the shaft of the main body that is operable for drilling a hole in a workpiece, and a cutting tip positioned at a distal end of the drill bit and operable to cut a countersink bore in said workpiece.

10. The tool of claim 9, wherein said cutting tip is secured around said drill bit using a second set screw.

11. The tool of claim 1, wherein the depth ring includes at least one window operable to evacuate wood cuttings from the workpiece.

12. A drilling countersink tool attachment device, the device comprising:
a. a drilling mechanism having a chuck operable to secure a cutting tool; and
b. a micro countersink tool removably coupled to the chuck, the micro countersink tool comprising:
c. a main body having a proximal end with a shank for engagement with the chuck and a distal end with an axial opening operable to receive a drill bit, the main body further comprising a threaded exterior portion and a plurality of exterior blind holes;
d. a micro barrel having an internal axial threaded bore configured to engage with the threaded exterior portion of the main body, wherein rotation of the micro barrel axially adjusts a position of a distal end of the tool;
e. a locking ring assembly having:
i. an outer cylindrical body,
ii. an interior cylindrical body connected to the outer cylindrical body by a plurality of supporting members,
iii. at least one magnet, and
iv. at least one dowel pin configured to engage with one of the plurality of blind holes to selectively lock the micro barrel in position;
f. a depth ring secured to the micro barrel, the depth ring comprising a plurality of windows operable to facilitate debris evacuation and cooling airflow; and
g. a cutting tip secured at the distal end of the tool and operable to form a countersunk bore in a workpiece when the tool is engaged with the drilling mechanism.

13. The device of claim 12, wherein the main body includes a plurality of indicator marks on a mid-region, the indicator marks being positioned to provide a visual reference for adjusting the depth of the cutting tip.

14. The device of claim 13, wherein the micro barrel includes a top edge, and a position of the top edge is compared to the plurality of indicator marks on the main body to indicate the depth of the cutting tip.

15. The device of claim 14, wherein the depth ring is rotatably coupled to the micro barrel via a bearing, allowing the depth ring to remain stationary relative to a workpiece while the drill bit and cutting tip rotate.

16. The device of claim 15, wherein the locking ring assembly is configured to slide along a smooth region of the main body between a locked position, where the dowel pin engages with at least one of the plurality of blind holes, and an adjustable position, where the dowel pin is disengaged to allow axial movement of the main body.

17. The device of claim 16, wherein the cutting tip is secured around the drill bit using a set screw.

18. A method for creating a countersunk hole and bore hole, the method comprising:
a. coupling a micro countersink tool to a drilling mechanism by securing a shank of the tool into a chuck of the drilling mechanism;
b. adjusting a cutting tip depth by:
i. biasing a locking ring assembly away from a main body to disengage a locking mechanism, wherein the locking mechanism includes at least one embedded magnet and at least one dowel pin operable for engagement with at least one of a plurality of blind holes on the main body;
ii. rotating the main body relative to a micro barrel, the micro barrel having an interior threaded axial bore with a threaded exterior portion of the main body, thereby axially moving a distal end of the tool; and
iii. re-engaging the locking ring assembly to secure the cutting tip in a desired position;
c. aligning the drill bit with a workpiece and activating the drilling mechanism to rotate the micro countersink tool;
d. drilling into the workpiece until a depth ring contacts a top surface of the workpiece, wherein the depth ring comprises a plurality of opening for debris evacuation and airflow; and
e. removing the micro countersink tool from the workpiece, leaving a bore and countersunk profile corresponding to the configuration of the cutting tip and drill bit.

19. The method of claim 18, wherein adjusting the cutting tip depth further comprises comparing a top edge of the micro barrel to a plurality of indicator marks on the main body to determine a depth setting before securing the locking ring assembly.

20. The method of claim 18, further comprising a bearing coupling between the depth ring and the micro barrel, wherein the depth ring remains stationary relative to the workpiece during rotation of the drill bit and cutting tip.
